(19) United States
(12) Patent Application Publication
(10) Pub. No.: US 2020/0002054 A1
(43) Pub. Date: Jan. 2, 2020

(54) DRINKING VESSEL WITH DETACHABLE CONTAINER

(71) Applicant: Christopher M. Gronkowski, Colleyville, TX (US)

(72) Inventor: Christopher M. Gronkowski, Colleyville, TX (US)

(21) Appl. No.: 16/023,453

(22) Filed: Jun. 29, 2018

(51) Int. Cl. B65D 21/02; A47J 43/27; B65D 81/38; B65D 81/32

(52) U.S. Cl. CPC B65D 21/022; A47J 43/27; A47G 19/2205; B65D 81/3205; B65D 81/3818

(57) ABSTRACT

A drinking vessel containing a drink container and a storage container, wherein the one or more magnets of the bottom wall of the drink container are configured to engage the one or more magnets the upper lid wall such that the storage container is removably secured to the drink container. Also, a kit containing the drinking vessel and one or more additional storage containers.

### TECHNICAL FIELD

The present application relates to a drinking vessel having a drink container and a storage container. Specifically, the present application relates to a drinking vessel that includes a drink container and a storage container that is magnetically and removably attached to the drink container such that the drink container and the storage container are securely attached but can be separated by hand. The drinking vessel of the present application allows a user to easily carry both the drink container and the storage container together in a secure manner.

### BACKGROUND

Exercise enthusiasts may utilize nutritional supplements, such as protein powders. Such nutritional supplements are often available as powders that can be added to liquids, such as water, to produce an easily consumable beverage that contains the desired nutritional supplement. Even though these easily consumable beverages can have the desired nutritional supplement, the taste of the beverage can be unpalatable when consumed at room temperature or warmer, and thus these beverages are generally preferred to be consumed at reduced temperatures. Based upon this preference of temperature, it can be beneficial to mix the easily consumable beverages shortly before consumption or, at least, to keep the easily consumable beverages cool prior to consumption.

Known drinking vessels, however, fail to disclose a drinking vessel that allows users to store nutritional supplements, such as protein powders, in a convenient way, while also maintaining a pleasant, cool beverage. For instance, U.S. Pat. Nos. 9,120,598 and 9,216,843 disclose arrangements of stackable containers, but these containers are inconveniently coupled with twist and lock type connections and lack insulation. U.S. 2015/0344194 has a similarly inconvenient attachment mechanism and lacks insulation. Also, U.S. 2016/0236819 discloses a magnetic feature, but the magnet is used to secure the shaker to exercise equipment. Thus, known drinking vessels are insufficient for the convenient use of exercise enthusiasts.

Also, nutritional supplements, such as protein powders, can cause known drinking vessels to develop an unpleasant odor. Known drinking vessels can succumb to such unpleasant odors.

Accordingly, there is a need in the art for a drinking vessel that allows a user to easily carry both the drink container and the storage container together in a secure manner, maintain a desired temperature, and avoid unpleasant odors.

### BRIEF SUMMARY

In view of the above-mentioned exemplary problems with conventional and known drinking vessels, the present application provides a drinking vessel and kit, as discussed below.

One aspect of the application includes a drinking vessel comprising a drink container and a storage container, wherein the drink container comprises an inner portion and an outer portion, the inner portion being nested inside of the outer portion such that the inner portion and outer portion form a drink container having an open top, a side wall, and a bottom wall, the inner portion and the outer portion enclosing an insulating space between the inner portion and the outer portion, and the bottom wall comprising one or more magnets, wherein the storage container comprises a lid and a storage body, wherein the lid comprises an upper lid wall and a side lid wall, the upper lid wall comprising one or more magnets, and the side lid wall having internal threads, and wherein the storage body comprises a threaded top portion, a storage side wall, and a storage bottom wall, the threaded top portion comprising external threads configured to engage the internal threads of the lid side wall, and wherein the one or more magnets of the bottom wall of the drink container are configured to engage the one or more magnets the upper lid wall such that the storage container is removably secured to the drink container.

In another aspect of the application, the inner portion and the outer portion of the drink container are joined together to form an upper threaded portion having external threads.

In another aspect of the application, the drinking vessel further comprising a cover portion comprising a cover top wall and a cover side wall, the cover side wall having internal threads.

In another aspect of the application, the inner portion and the outer portion of the drink container are joined together to form an upper threaded portion having external threads, and further comprising a cover portion comprising a cover top wall and a cover side wall, the cover side wall having internal threads, wherein the open top of the drink container further comprises a threaded top portion comprising external threads, the internal threads of the cover side wall being configured to engage the external threads of the threaded top portion.

In another aspect of the application, the drink container is metal.

In another aspect of the application, the storage container is metal.

In another aspect of the application, the lid is metal.

In another aspect of the application, the drink container is plastic.

In another aspect of the application, the storage container is plastic.

In another aspect of the application, the lid is plastic.

In another aspect of the application, the drink container has a conical shape such that the drink container has a diameter at the bottom wall that is less than a diameter at the open top.

In another aspect of the application, the lid and the storage body each have a cylindrical shape such that an outer diameter of the lid and an outer diameter of the storage body are substantially the same.

In another aspect of the application, the outer portion of the drink container has a diameter at the bottom wall that is substantially the same as the outer diameter of the lid and the outer diameter of the storage body.

In another aspect of the application, the bottom wall has an indented portion and the upper lid wall has a raised portion, and the raised portion is configured to occupy the indented portion of the bottom wall.

In another aspect of the application, the one or more magnets of the bottom wall of the drink container and the one or more magnets of the upper lid wall are each ring shaped.

In another aspect of the application, the one or more magnets of the bottom wall of the drink container and the one or more magnets of the upper lid wall are each a disc.

In another aspect of the application, the storage body of the storage container comprises an inner wall and an outer wall enclosing an insulating space between the inner wall of the the storage body and the outer wall of the storage body.

Yet another aspect of the application includes a kit comprising the above-discussed drinking vessel and one or more additional storage containers, wherein the one or more additional storage containers comprise a lid and a storage body, wherein the lid comprises an upper lid wall and a side lid wall, the upper lid wall comprising one or more magnets, and the side lid wall having internal threads, and wherein the storage body comprises a threaded top portion, a storage side wall, and a storage bottom wall, the threaded top portion comprising external threads configured to engage the internal threads of the lid side wall.

Other objects, features and advantages of the present invention will be apparent to those of ordinary skill in the art in view of the following detailed description of the invention and accompanying drawings.

### BRIEF DESCRIPTION OF THE DRAWINGS

The drawings as provided for herein set forth some exemplary embodiments of the drinking vessel of the present application, the detailed description of which follows. The drawings are merely exemplary and are clearly not intended to limit the invention.

FIG. 1 is a side view of one embodiment of the drinking vessel.

FIG. 2 is an enlarge side view of the embodiment of FIG. 1 showing an exemplary interface between the drink container and the storage container.

FIG. 3 is a flow chart of one embodiment of the drinking vessel showing the drink container and the storage container being separated by hand.

FIG. 4 is an exploded side view of the embodiment of FIG. 1.

### DETAILED DESCRIPTION

The drinking vessel and kit are now described by reference to the embodiments. The description provided herein is not intended to limit the scope of the present claims, but to exemplify the variety encompassed by the present application. The embodiments are described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

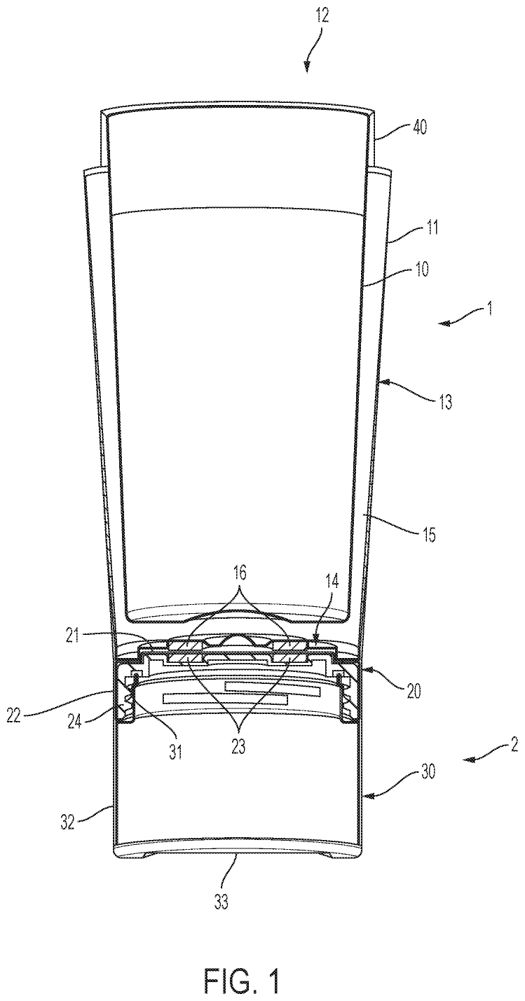

As seen in FIG. 1, the drinking vessel of the present application includes a drink container (1) and a storage container (2). The drink container (1) includes an inner portion (10) and an outer portion (11). The inner portion (10) can be nested inside of the outer portion (11) such that the inner portion (10) and outer portion (11) form the drink container (1) having an open top (12), a side wall (13), and a bottom wall (14).

The inner portion (10) and the outer portion (11) enclose an insulating space (15) between the inner portion (10) and the outer portion (11). The insulating space (15) can be a void, be filled with one or more insulating materials, or have a mixed construction of one or more voids and one or more insulating materials. Such a construction is commonly referred to as a double-walled construction, and is used for travel mugs, coolers, etc. However, the drink container (1) is not limited to such double-walled construction, and can further include additional elements, such as an intermediate wall, to have a triple-walled construction, etc. Also, even though the general preference for a cooled beverage is discussed above, the insulation can allow users to maintain the temperatures of warm beverages as well, if desired. For instance, the drink container (1) could contain hot water and a storage container (2) could contain chocolate powder, thereby allowing the user to produce a “hot chocolate” beverage.

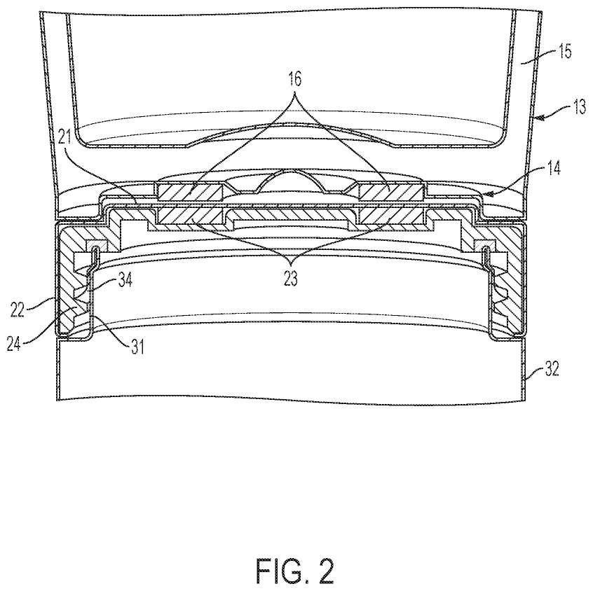

The bottom wall (14) of the drink container (1) can further include one or more magnets (16). In the embodiment shown in FIG. 2, the one or more magnets (16) are embedded within the bottom wall (14) by a plate securing the the one or more magnets (16) within voids in bottom wall (14). However, the one or more magnets (16) can be included in the bottom wall (14) in several alternative ways. For instance, the one or more magnets (16) can be affixed to an interior surface or an exterior surface of bottom wall by gluing, welding, tape, etc., and in each of these instances voids may or may not be utilized to affix the one or more magnets (16) to the bottom wall (14).

The one or more magnets (16) can also have a variety of shapes. For instance, the one or more magnets (16) can be individual magnets evenly or unevenly spaced on the bottom wall (14). The one or more magnets (16) can be ring shaped, i.e., washer shaped having both an inner and an outer diameter. In another embodiment, the one or more magnets (16) can be circular shaped, i.e., disc shaped, such that the diameter of a circular shaped magnet can be less than or equal to the diameter of the bottom wall (14). The one or more magnets (16) can also be placed on either an inner surface and/or an outer surface of the bottom wall (14).

The drinking vessel of the present application can additionally include a storage container (2). The storage container (2) can include a lid (20) and a storage body (30). The lid (20) can include an upper lid wall (21) and a side lid wall (22). The side lid wall (22) can have internal threads (24). Also, the upper lid wall (21) can include one or more magnets (23). As seen in FIG. 2, the one or more magnets (23) can be embedded within the upper lid wall (21) by securing the one or more magnets (23) within voids in upper lid wall (21). However, the one or more magnets (23) can be included in the upper lid wall (21) in several alternative ways. For instance, the one or more magnets (23) can be affixed to an interior surface or an exterior surface of bottom wall by gluing, welding, tape, etc., and in each of these instances voids may or may not be utilized to affix the one or more magnets (23) to the upper lid wall (21). Also, the one or more magnets (23) can have a variety of shapes. For instance, the one or more magnets (23) can be individual magnets evenly or unevenly spaced on the upper lid wall (21). The one or more magnets (23) can be ring shaped, i.e., washer shaped having both an inner and an outer diameter. In another embodiment, the one or more magnets (23) can be circular shaped, i.e., disc shaped, such that the diameter of a circular shaped magnet can be less than or equal to the diameter of the upper lid wall (21). The one or more magnets (23) can also be placed on either an inner surface and/or an outer surface of the upper lid wall (21).

The one or more magnets (16) of the bottom wall (14) of the drink container (1) can be configured to engage the one or more magnets (23) the upper lid wall (21) such that the storage container (2) can removably secured to the drink container (1). As seen in FIGS. 1, 2, and 4, the one or more magnets (16) of the bottom wall (14) and the one or more magnets (23) of the upper lid wall (21) are arranged such that spacing of the magnets substantially corresponds. In such a situation the polarity of the one or more magnets (16, 23) are arranged such that the magnets are attracted to each other, rather than repelling each other. If necessary, a mixture of polarities and magnetic materials can be used to achieve an appropriate force of attraction.

In an alternative embodiment, the bottom wall (14) of the drink container (1) can be made of material that is magnetic such that the one or more magnets (23) of the upper lid wall (21) can removably secure the storage container (2) to the drink container (1) without the need for the one or more magnets (16) of the bottom wall (14) of the drink container. In another alternative embodiment, the upper lid wall (21) of the lid (20) can be made of material that is magnetic such that the one or more magnets (16) of the bottom wall (14) can removably secure the storage container (2) to the drink container (1) without the need for the one or more magnets (23) of the upper lid wall (21).

A variety of magnetic and non-magnetic materials can be used for the drink container (1) and storage container (2), as well as plastic materials. For instance, stainless steels and aluminum alloys, including food grade stainless steels. In particular, stainless steel grade 430 and 80/0 are both food grade, magnetic stainless steels that may be acceptably used. 300-series stainless steels are non-magnetic, food grade stainless steels that may also be acceptably used. Also, plastics, such as polyethylene terephthalate (PET or PETE or polyester), high density polyethylene (HDPE), polyvinyl chloride (V or Vinyl or PVC), low density polyethylene (LDPE), polypropylene (PP), polystyrene (PS), etc. can be used.

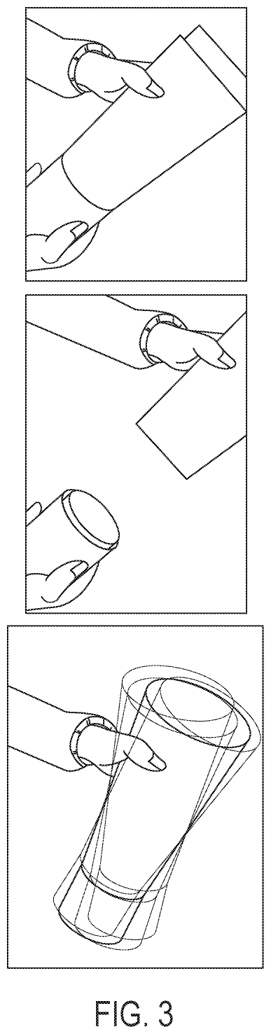

In each of the above-mentioned embodiments, the force required to separate the storage container (2) and the drink container (1) is hand-force. That is, an individual can remove separate the storage container (2) and the drink container (1) without the use of machinery. However, as seen in FIG. 3, the storage container (2) and the drink container (1) do not separate with simple movements or shaking. Rather, the user can intentionally separate the storage container (2) and the drink container (1) with hand-force.

The storage body (30) can include a threaded top portion (31), a storage side wall (32), and a storage bottom wall (33). The threaded top portion (31) can include external threads (34) configured to engage the internal threads (24) of the lid side wall (22) such that the lid (20) and the storage body (30) are securely attached to each other.

Further, in another embodiment, the inner portion (10) of the drink container (1) and the outer portion (11) of the drink container (1) are joined together to form an upper threaded portion (40) having external threads. The drinking vessel can also include a cover portion comprising a cover top wall and a cover side wall. The cover side wall can have internal threads that engage the external threads of the upper threaded portion (40) to secure the cover portion the upper threaded portion (40). The cover portion can also include a hole, straw, hinged cover, etc. to allow a liquid to pass through the cover portion. In an alternative embodiment, the cover portion can be secured to the drink container (1) by friction. For instance, the cover portion can include a washer or an “o ring” that allows the cover to be secured to the drink container (1) without the need for threading.

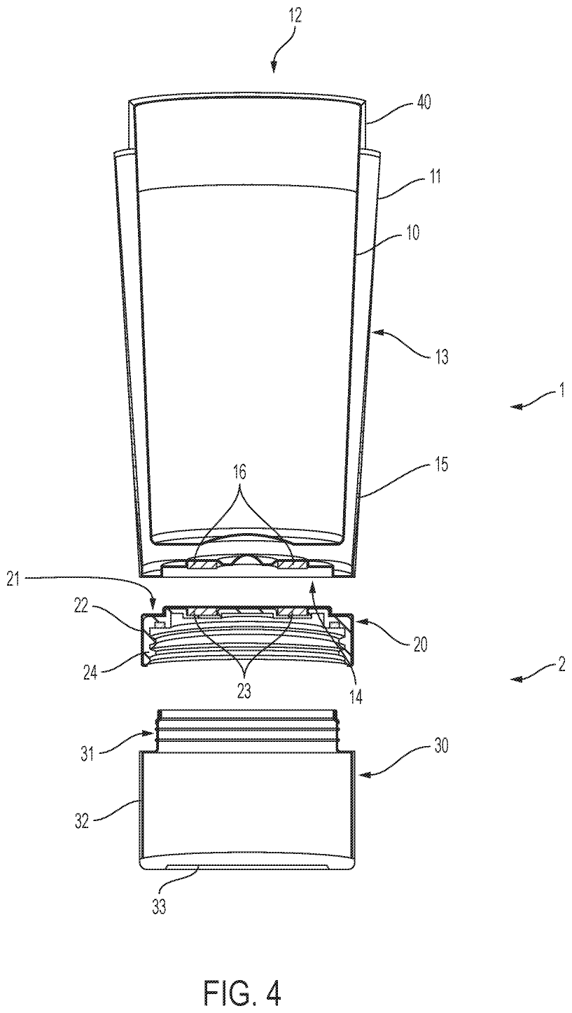

In yet another embodiment, the drink container (1) has a conical shape such that the drink container (1) has a diameter at the bottom wall (14) that is less than a diameter at the open top (12). The conical shape can be seen in FIGS. 1 and 4. By having a conical shape, the drink container (1) can fit comfortably in the hand of the user. Also, the conical shape can help frictionally secure the drinking vessel in a cup holder, and even prevent the drinking vessel from fall through an open-bottom cup holder.

The lid (20) and the storage body (30) can each have a substantially cylindrical shape such that an outer diameter of the lid and an outer diameter of the storage body are substantially the same. The substantially cylindrical shape can be seen in FIGS. 1 and 4. Also, the outer portion of the drink container (1) can have a diameter at the bottom wall (14) that is substantially the same as the outer diameter of the lid (20) and the outer diameter of the storage body (30). By having substantially the same outer diameter, the drink container (1) and the storage container (2) can have a smooth joint therebetween. The smooth joint allows the drinking vessel to be inserted and removed from cup holders without getting caught on a portion jutting out, thereby improving user experience.

Further, in an embodiment, the bottom wall (14) has an indented portion and the upper lid wall (21) has a raised portion. The raised portion of the upper lid wall (21) can be configured to occupy the indented portion of the bottom wall (14). By having the raised portion of the upper lid wall (21) occupy the indented portion of the bottom wall (14), the storage container (2) can have radial support to prevent the storage container (2) from slipping in a radial direction. As discussed above, the drinking container (1) and the storage container (2) can be secured by magnetic force. Thus, reducing radial slippage by the aforementioned indented portion can prevent the drinking container (1) and the storage container (2) from being unintentionally detached and also reduce the need for extremely strong magnets.

In an embodiment, the storage body (30) of the storage container (2) can have an inner wall and an outer wall enclosing an insulating space between the inner wall of the the storage body and the outer wall of the storage body. The insulating space in this embodiment can be a void, be filled with one or more insulating materials, or have a mixed construction of one or more voids and one or more insulating materials. As mentioned above, such a construction is commonly referred to as a double-walled construction. However, the storage body (30) of the storage container (2) is not limited to such double-walled construction, and can further include additional elements, such as an intermediate wall, to have a triple-walled construction, etc.

Another embodiment is a kit containing the above-described drinking vessel and one or more additional storage containers. The additional storage containers are described in detail above with reference to the storage container (2). Since the storage container (2) is removably secured to drink container (1), it may be beneficial for an end users to possess additional storage containers. For instance, a possible use of the drinking vessel is storing an amount of protein powder in the storage container during a workout session, and then adding the protein powder to the drinking container immediately after or during the workout session. The user may desire a measured amount of protein powder, and it would be beneficial for the user to possess one or more additional storage containers so the user could premeasure several sessions of protein at once. For example, if a user wanted to work out in the morning and afternoon, and drink a protein shake during or after each session, the user could premeasure the appropriate amount of protein powder the night before and place the protein powder into two separate storage containers. The user could then bring one storage container to the morning workout session, and then bring the second storage container to the afternoon workout session. Additionally, the user may desire to premeasure several days or weeks of protein powder, and thus the number of storage container in the kit of the present embodiment is not limited. In this regard, the user may wish to possess seven additional storage containers so that the protein powder is only measured once per week, if the user desires one protein drink per day. Even though protein powder is discussed in the above-example, a variety of different foods, supplements, pills, medicines, supplemental liquids and/or gels, etc. can be stored in storage container, and thus the application is not limited to protein powder. Even further, the storage container could be used for non-edibles, such as keys, watches, etc.

Because the storage containers may have one or more magnets in the lid, the one or more additional storage containers could be stored on a calendar that would allow storage container to be removably secured to the calendar. Also, the one or more additional storage containers could be removably secured to kitchen equipment or workout equipment by the magnetic properties of the one or more magnets in the lid.

In the foregoing description, the drinking vessel and kit have been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification, unless the context requires otherwise, the word “comprise” and its variations, such as “comprises” and “comprising,” will be understood to imply the inclusion of a stated item, element or step or group of items, elements or steps, but not the exclusion of any other item, element or step or group of items, elements or steps. Furthermore, the indefinite article “a” or “an” is meant to indicate one or more of the item, element or step modified by the article.

1. A drinking vessel comprising a drink container and a storage container,
wherein the drink container comprises an inner portion and an outer portion, the inner portion being nested inside of the outer portion such that the inner portion and outer portion form a drink container having an open top, a side wall, and a bottom wall, the inner portion and the outer portion enclosing an insulating space between the inner portion and the outer portion, and the bottom wall comprising one or more magnets,
wherein the storage container comprises a lid and a storage body,
wherein the lid comprises an upper lid wall and a side lid wall, the upper lid wall comprising one or more magnets, and the side lid wall having internal threads, and
wherein the storage body comprises a threaded top portion, a storage side wall, and a storage bottom wall, the threaded top portion comprising external threads configured to engage the internal threads of the lid side wall, and
wherein the one or more magnets of the bottom wall of the drink container are configured to engage the one or more magnets the upper lid wall such that the storage container is removably secured to the drink container.

2. The drinking vessel of claim 1, wherein the inner portion and the outer portion of the drink container are joined together to form an upper threaded portion having external threads.

3. The drinking vessel of claim 1, further comprising a cover portion comprising a cover top wall and a cover side wall, the cover side wall having internal threads.

4. The drinking vessel of claim 1, wherein the inner portion and the outer portion of the drink container are joined together to form an upper threaded portion having external threads, and further comprising a cover portion comprising a cover top wall and a cover side wall, the cover side wall having internal threads, wherein the open top of the drink container further comprises a threaded top portion comprising external threads, the internal threads of the cover side wall being configured to engage the external threads of the threaded top portion.

5. The drinking vessel of claim 1, wherein the drink container is metal.

6. The drinking vessel of claim 1, wherein the storage container is metal.

7. The drinking vessel of claim 1, wherein the lid is metal.

8. The drinking vessel of claim 1, wherein the drink container is plastic.

9. The drinking vessel of claim 1, wherein the storage container is plastic.

10. The drinking vessel of claim 1, wherein the lid is plastic.

11. The drinking vessel of claim 1, wherein the drink container has a conical shape such that the drink container has a diameter at the bottom wall that is less than a diameter at the open top.

12. The drinking vessel of claim 1, wherein the lid and the storage body each have a cylindrical shape such that an outer diameter of the lid and an outer diameter of the storage body are substantially the same.

13. The drinking vessel of claim 12, wherein the outer portion of the drink container has a diameter at the bottom wall that is substantially the same as the outer diameter of the lid and the outer diameter of the storage body.

14. The drinking vessel of claim 1, wherein the bottom wall has an indented portion and the upper lid wall has a raised portion, and wherein the raised portion is configured to occupy the indented portion of the bottom wall.

15. The drinking vessel of claim 1, wherein the one or more magnets of the bottom wall of the drink container and the one or more magnets of the upper lid wall are each ring shaped.

16. The drinking vessel of claim 1, wherein the one or more magnets of the bottom wall of the drink container and the one or more magnets of the upper lid wall are each a disc.

17. The drinking vessel of claim 1, wherein the storage body of the storage container comprises an inner wall and an outer wall enclosing an insulating space between the inner wall of the storage body and the outer wall of the storage body.

18. A kit comprising the drinking vessel of claim 1 and one or more additional storage containers,
wherein the one or more additional storage containers comprise a lid and a storage body,
wherein the lid comprises an upper lid wall and a side lid wall, the upper lid wall comprising one or more magnets, and the side lid wall having internal threads, and
wherein the storage body comprises a threaded top portion, a storage side wall, and a storage bottom wall, the threaded top portion comprising external threads configured to engage the internal threads of the lid side wall.
